(19) United States
(12) Patent Application Publication
(10) Pub. No.: US 2026/0045197 A1
(43) Pub. Date: Feb. 12, 2026

(54) Source driver with digital-to-analog converter structure for various parts of gamma curve

(71) Applicant: NOVATEK Microelectronics Corp., Hsin-Chu (TW)

(72) Inventors: Yi-Jiang Hu, New Taipei City (TW); Chi-Ting Chen, Hsinchu City (TW); Kuo-Jen Hsu, Taipei City (TW); Hong-Chih Lin, Tainan City (TW)

(73) Assignee: NOVATEK Microelectronics Corp., Hsin-Chu (TW)

(21) Appl. No.: 18/797,444

(22) Filed: Aug. 7, 2024

(51) Int. Cl. G09G 3/20

(52) U.S. Cl. CPC G09G 3/2007; G09G 2310/027; G09G 2310/0291; G09G 2320/0276; G09G 2320/0673

(57) ABSTRACT

A source driver includes a digital-to-analog converter (DAC), comprising: a m-bit sub-DAC, configured to receive a plurality of first data codes within a plurality of data codes and generate a set of first intermediate voltages according to the plurality of first data codes; and a k-bit sub-DAC, configured to receive a plurality of second data codes within the plurality of data codes and generate a set of second intermediate voltages according to the plurality of second data codes; and an operational amplifier, configured to output a data voltage according to the set of first intermediate voltages or the set of second intermediate voltages; wherein m and k are positive integers.

### BACKGROUND OF THE INVENTION

### 1. Field of the Invention

The present invention relates to a source driver, and more particularly, to a source driver capable of improving output linearity for various parts of a gamma curve.

### 2. Description of the Prior Art

As modern display panels evolve towards wide color gamuts, the requirements of output grayscales in display driver integrated circuits (DDICs) also increase. The expansion of grayscales results in a significant increase of the area occupied by digital-to-analog converters (DACs) within the source driver of the DDIC, leading to higher costs. To address, the differential difference amplifier (DDA) offers a solution for reducing DAC usage. However, the output voltage range of a DDA is limited due to linearity issues. Despite the ongoing increase in the grayscale values, the performance of the DDA's output cannot keep pace with the increasing grayscale values. In such a situation, the circuit area of the DDIC may still grow as grayscales increase. Thus, there is a need for improvement over the prior art.

### SUMMARY OF THE INVENTION

It is therefore an objective of the present invention to provide a source driver including a digital-to-analog converter for providing input voltages to a differential difference amplifier (DDA), so as to improve the linearity of the DDA's output. This helps improve the output accuracy of the DDA and also increase the output range of the DDA.

An embodiment of the present invention discloses a source driver, where the source driver includes a digital-to-analog converter (DAC), comprising: a m-bit sub-DAC, configured to receive a plurality of first data codes within a plurality of data codes and generate a set of first intermediate voltages according to the plurality of first data codes; and a k-bit sub-DAC, configured to receive a plurality of second data codes within the plurality of data codes and generate a set of second intermediate voltages according to the plurality of second data codes; and an operational amplifier, configured to output a data voltage according to the set of first intermediate voltages or the set of second intermediate voltages; wherein m and k are positive integers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a source driver of a display driver circuit.

FIG. 2 illustrates an exemplary implementation of the SOP to realize the DDA operations.

FIG. 3 illustrates the relation of the output voltage versus the data code in a DDA operation.

FIG. 4 is a schematic diagram of a source driver according to an embodiment of the present invention.

FIG. 5 is a schematic diagram of a source driver according to another embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

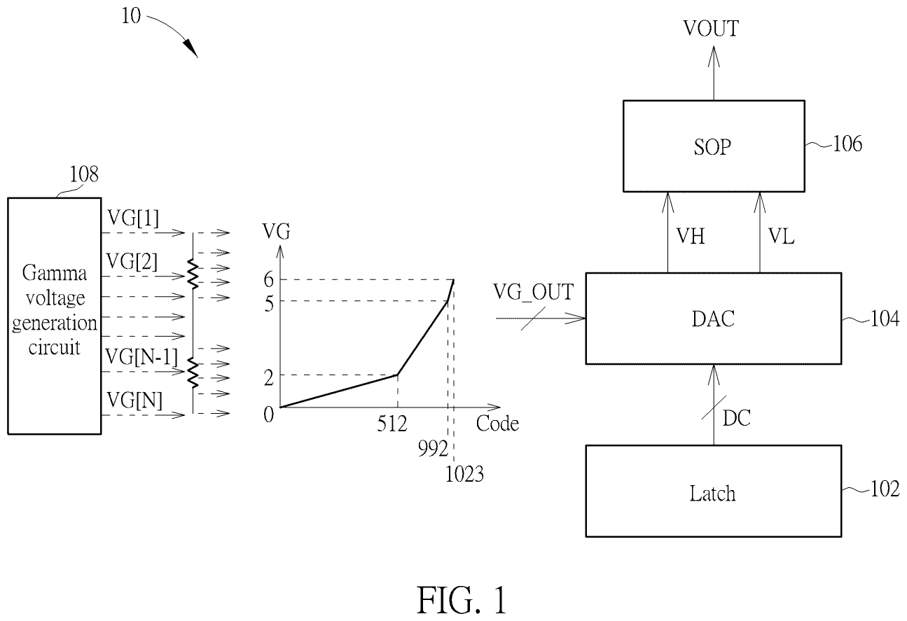

Please refer to FIG. 1. FIG. 1 is a schematic diagram of a source driver 10 of a display driver circuit, which may be implemented in a display driver integrated circuit (DDIC). The source driver 10 includes a latch circuit 102, a digital-to-analog converter (DAC) 104 and a source operational amplifier (SOP) 106. FIG. 1 also illustrates a gamma voltage generation circuit 108, which may be included in the source driver 10 or coupled to the source driver 10. The gamma voltage generation circuit 108 is configured to provide gamma voltages VG_OUT for the DAC 104. In this example, the gamma voltage generation circuit 108 generates multiple gamma tap voltages VG[1]-VG[N], which are divided by a resistor string to generate 2¹⁰=1024 gamma voltages VG_OUT[1]-VG_OUT[1024] to be provided for the DAC 104 in the source driver 10. The SOP 106 is a differential difference amplifier (DDA) capable of performing interpolation on the received input voltages (including a high voltage VH and a low voltage VL) to generate a data voltage VOUT. The data voltage VOUT is used to drive target pixels on the display panel.

In the source driver 10, the latch circuit 102 may receive and output a data code DC (e.g., grayscale value) to the DAC 104. Based on the DDA operations, the DAC 104 may output a high voltage VH and a low voltage VL corresponding to several bits of the data code DC received from the latch circuit 102. For example, the DAC 104 may select two or more gamma voltages as the high voltage VH and the low voltage VL from 1024 gamma voltages VG_OUT of the gamma voltage generation circuit 108 to be output to the SOP 106 according to the higher bits within the data code DC. The SOP 106 thereby generates the data voltage VOUT according to the high voltage VH and the low voltage VL, where the data voltage VOUT may be a voltage between the high voltage VH and the low voltage VL generated through interpolation. The interpolation may be performed based on other bits of the data code DC.

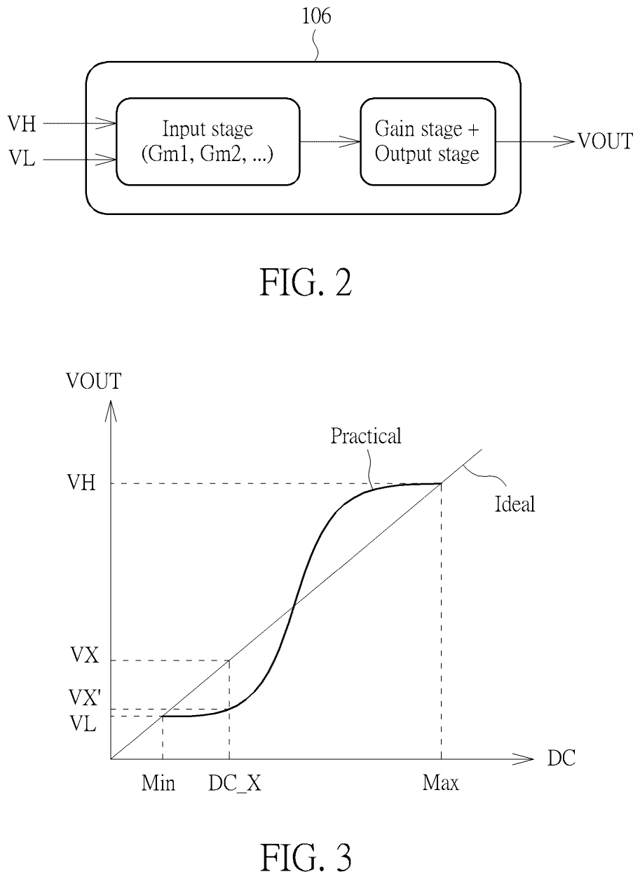

FIG. 2 illustrates an exemplary implementation of the SOP 106 to realize the DDA operations. As shown in FIG. 2, the SOP 106 may be generally divided into an input stage, a gain stage and an output stage. In this embodiment, the DDA operations may be implemented in the input stage, in which the transconductances Gm1, Gm2. . . may be modified according to the data code DC, to generate an interpolation voltage as the data voltage VOUT. In general, by receiving N bits of the data code DC, the SOP 106 may perform N-bit interpolation to generate the data voltage VOUT, where N may be any appropriate integer. For example, if a 4-bit DDA operation is applied, the SOP 106 is able to generate 16 different output voltages VOUT between the high voltage VH and the low voltage VL, and the voltage step will be approximately 1/16 of the voltage difference of VH and VL. The values of the transconductances Gm1, Gm2. . . may be preconfigured to appropriate values to generate the desired values of the data voltage VOUT. In an embodiment, the values of the transconductances Gm1, Gm2. . . may be modified by controlling the current sources for supplying bias currents to input pairs in the input stage.

However, when the bit number used for interpolation increases, the linearity of the data voltage VOUT will be degraded; that is, the voltage step between two adjacent values of the data voltage VOUT might be deviated from 1/16 of the voltage difference of VH and VL in the 4-bit DDA operation. For example, as shown in FIG. 3, the SOP 106 may receive the high voltage VH and the low voltage VL to perform interpolation in response to the data code DC, where the high voltage VH may correspond to a maximum data code (Max) and the low voltage VL may correspond to a minimum data code (Min). In the range between the high voltage VH and the low voltage VL, the relation of the data voltage VOUT versus the data code DC should be a straight line ideally. However, in a practical circuit implementation of the SOP 106, the relation of the data voltage VOUT versus the data code DC may be non-linear, resulting in a non-linear curve as shown in FIG. 3. For example, as for a data code DC_X, the SOP 106 is predicted to output the data voltage VOUT equal to Vx ideally, but the non-linear relationship causes the data voltage VOUT to be equal to Vx′, which means that a linear error voltage of the data voltage VOUT is (VX-VX′) .

This non-linear relationship may originate from the transconductance of the SOP 106, which may be generated from the input transistors in the input stage, where the input transistors have a non-linear voltage-to-current transition behavior. More specifically, the input stage aims at generating a differential current to be supplied to the gain stage, where the differential current value is determined based on the input voltages (i.e., VH and VL) and the transconductance values of the SOP 106. The transition from the input voltages to the differential current may follow a square law of the input transistors that may not be linear. In such a situation, the interpolation voltage generated based on the variations of the transconductance values may also possess the non-linear characteristics, which generates a DDA error on the data voltage VOUT.

Furthermore, the transconductances Gm1, Gm2. . . of the SOP 106 are also related to both the input voltage (i.e. VH and VL) and the data voltage VOUT. In such a situation, the DDA error of the data voltage VOUT will increase as the difference between the high voltage VH and the low voltage VL becomes larger. For example, the Gamma curve on the left part of FIG. 1 illustrates the expected specification of the display manufacture for grayscale-to-output voltage. The Gamma curve of this expected specification may correspond to the gamma values expected to be achieved by the display device, such as gamma 2.2 or gamma 1.8. As shown in FIG. 1, the Gamma curve has significantly different slopes corresponding to a first output voltage (0V-2V) and a second output voltage (2V-6V). Therefore, for the first output voltage (0V-2V) and the second output voltage (2V-6V), the DAC 104 selects the same number of gamma voltages (e.g., 16 gamma voltages VG_OUT each) from 1024 gamma voltages VG_OUT of the gamma voltage generation circuit 108 according to the higher multiple bits within the data code DC. The selected gamma voltages are output to the SOP 106 as the high voltage VH and the low voltage VL. As a result, the difference between two adjacent values in the gamma voltage selected corresponding to the second output voltage range (2V-6V) should be greater than the difference between two adjacent values in the gamma voltage selected corresponding to the first output voltage range (0V-2V). In short, the DDA error corresponding to the data voltage VOUT of the second output voltage range (2V-6V) should be greater than the DDA error corresponding to the data voltage VOUT of the first output voltage range (0V-2V).

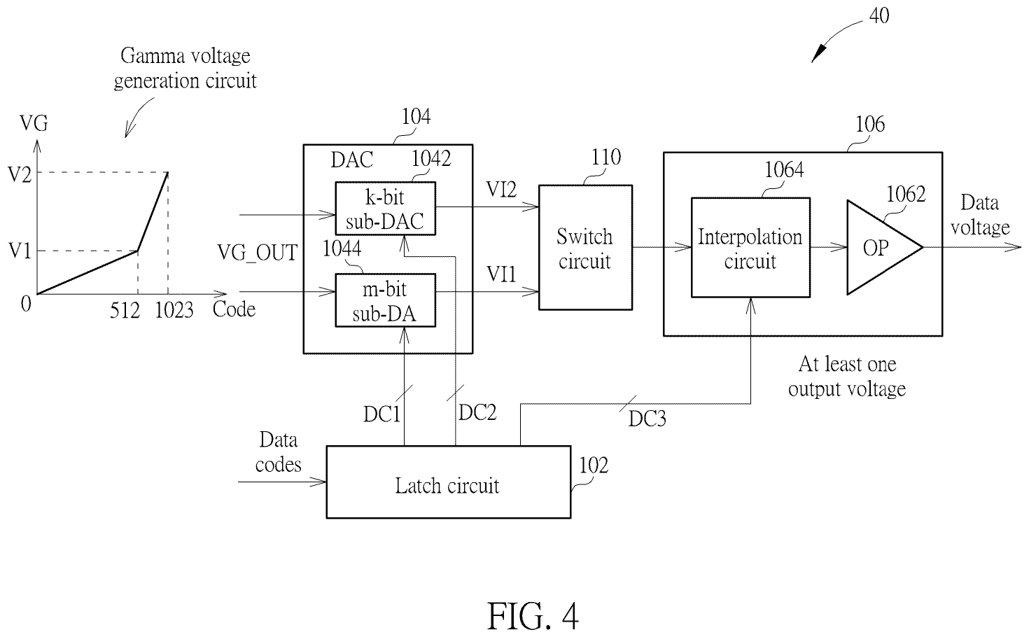

In order to improve the linearity of the data voltage VOUT, the present invention provides a source driver 40 that may select an appropriate number of gamma voltages from the 1024 gamma voltages VG_OUT of the gamma voltage generation circuit 108 as the high voltage VH and the low voltage VL for various output voltage ranges (for example, the first output voltage range and the second output voltage). FIG. 4 is a schematic diagram of a source driver 40 according to an embodiment of the present invention. The source driver 40 is derived from the source driver 10, so the same components are represented by the same symbols. The source driver 40 includes a latch circuit 102, a DAC 104 and a SOP 106. The latch circuit 102 may receive the data code DC (such as grayscale value) and output the data code DC to the DAC 104. The DAC 104 includes an m-bit sub-DAC 1044 and a k-bit sub-DAC 1042. The m-bit sub-DAC 1044 may receive a plurality of first data codes DC1 among the data code DC and generate a set of first intermediate voltages VI1 accordingly. The k-bit sub-DAC 1042 may receive a plurality of second data codes DC2 among the data code DC and generate a set of second intermediate voltages VI2 accordingly. For example, the m-bit sub-DAC 1044 may select two or more first gamma voltages as the first intermediate voltages VI1 from the first 512 gamma voltages VG_OUT (corresponding to the first part 0-V1 of the full gamma voltage range) within the 1024 gamma voltages VG_OUT (corresponding to a full gamma voltage range 0-V2) of the gamma voltage generation circuit 108 according to the plurality of first data codes DC1, and output the selected gamma voltages to the SOP 106. The k-bit sub-DAC 1042 may select two or more second gamma voltages as the second intermediate voltages VI2 from the last 512 gamma voltages VG_OUT (corresponding to a second part V1-V2 of the full gamma voltage range) within the 1024 gamma voltages VG_OUT (corresponding to the full gamma voltage range 0-V2) of the gamma voltage generation circuit 108 according to the plurality of second data codes DC2, and output the selected gamma voltages to the SOP 106. It should be noted that the first part does not overlap the second part.

Furthermore, the source driver 40 may further include a switch circuit 110 coupled between the DAC 104 and the SOP 106. The switch circuit 110 may receive the first intermediate voltages VI1 and the second intermediate voltages VI2, and switch the m-bit sub-DAC 1044 or the k-bit sub-DAC 1042 to be coupled to the SOP 106 according to the plurality of first data codes DC1 and the plurality of second data codes DC2. In other words, the switch circuit 110 may switch the first intermediate voltages VI1 or the second intermediate voltages VI2 to be output to the SOP 106. Specifically, the SOP 106 is the DDA including an interpolation circuit 1064 and an operational amplifier 1062. The interpolation circuit 1064 may receive the first intermediate voltages VI1 or the second intermediate voltages VI2 as the high voltage VH and the low voltage VL, and perform interpolation on the first intermediate voltages VI1 or the second intermediate voltages VI2 according to a plurality of third data codes DC3 among the data codes DC to generate at least one output voltage. The operational amplifier 1062 then amplifies the at least one output voltage to generate the data voltage VOUT. The data voltage VOUT is used to drive target pixels on the display panel. It should be noted that m, k, j are positive integers and may be the same or different. In this way, the source driver 40 of the present invention selects an appropriate number of gamma voltages as the high voltage VH and the low voltage VL for various output voltage ranges to improve the linearity of the data voltage VOUT

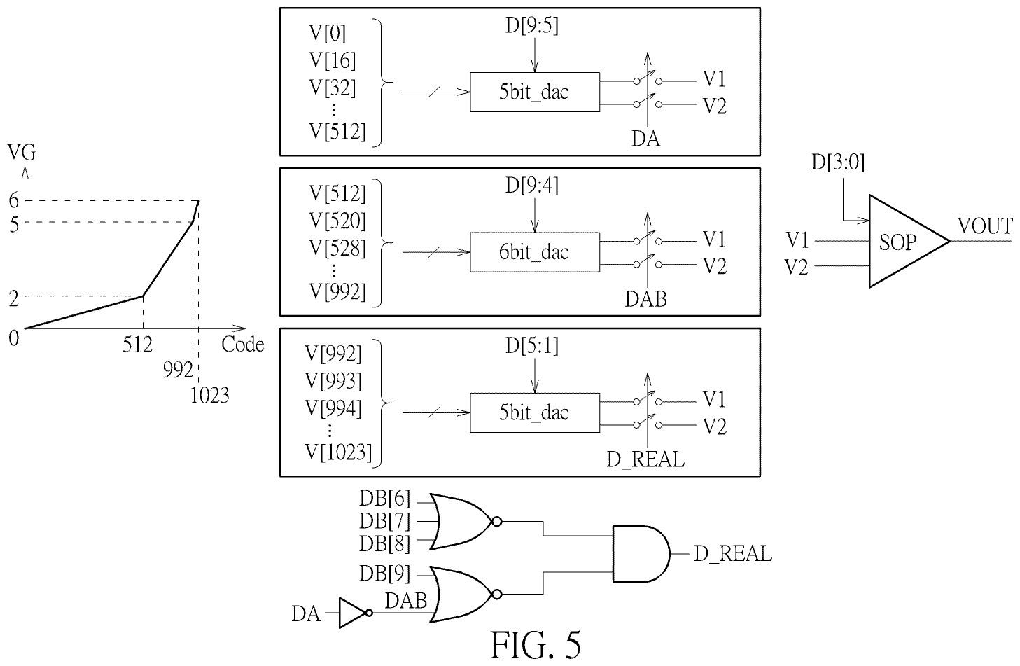

It should be noted that FIG. 4 is only an embodiment of the present invention, and those skilled in the art may make appropriate adjustments according to the system requirements. For example, the expected specifications of the display manufacturer for grayscale-to-output voltage represent a more complex gamma curve. In order to improve the linearity of the data voltage VOUT, the DAC 104 of the present invention may include more sub-DACs, such as three sub-DACs, but is not limited thereto. Please refer to FIG. 5, which is a schematic diagram of a source driver 50 according to an embodiment of the present invention. The DAC 104 of the source driver 50 includes a first sub-DAC (5-bit), a second sub-DAC (6-bit) and a third sub-DAC (5-bit), which respectively correspond to the first part (0-2V), the second part (2-5V) and the third part (5-6V) in the full gamma voltage range (0-6V). In detail, the first sub-DAC (5-bit) receives the data code D[9:5] to select 16 first gamma voltages (V[0], V[16], V[32], . . . V[512]) as the first intermediate voltages VI1 from the first 512 gamma voltages VG_OUT (corresponding to the first part 0-2V) within the 1024 gamma voltages VG_OUT of the gamma voltage generation circuit 108 and output to the SOP 106. The second sub-DAC (6-bit) receives the data code D[9:4] to select 60 second gamma voltages (V[512], V[520], V[528], . . . , V[992]) as the second intermediate voltages VI2 from the 512-992 gamma voltages VG_OUT (corresponding to the second part 2-5V of the full gamma voltage range) within the 1024 gamma voltages VG_OUT of the gamma voltage generation circuit 108 and output to the SOP 106. The third sub-DAC (5-bit) receives the data code D[5:1] to select 32 third gamma voltages (V[992], V[993], V [994], . . . , V[1023]) as the third intermediate voltage VI3 from the 992-1024 gamma voltages VG_OUT (corresponding to the third part 5-6V of the full gamma voltage range) within the 1024 gamma voltages VG_OUT of the gamma voltage generation circuit 108 and output to the SOP 106. Specifically, the voltage difference of two adjacent first gamma voltages is 65.5 mV, and the corresponding linear error is approximately 0.4 mV; the voltage difference of two adjacent second gamma voltages is 50 mV, and the corresponding linear error is approximately 0.4 mV; the voltage difference of two adjacent third gamma voltages is 31.25 mV, and the corresponding linear error is approximately 0.4 mV. Compared with the conventional 6-bit DAC, the 64 gamma voltages (V[0], V[16], V[32], . . . , V[1023]) are selected as the intermediate voltages from the 1024 gamma voltages VG_OUT and output to the SOP 106. For the gamma voltages (V[0], V[16], V[32], . . . , V[512]) corresponding to the first part 0-2V of the full gamma voltage range, the voltage difference of two adjacent gamma voltages is 65.5 mV, and the corresponding linear error is approximately 0.4 mV; for the gamma voltages (V[512], V[528], . . . , V[992]) corresponding to the second part 2-5V of the full gamma voltage range, the voltage difference of two adjacent gamma voltages is 100 mV, and the corresponding linear error is approximately 1.5 mV; for the gamma voltages (V[992], V[1008], . . . , V[1023]) corresponding to the third part 5-6V of the full gamma voltage range, the voltage difference of two adjacent gamma voltages is 500 mV, and the corresponding linear error is approximately 20 mV. In other words, the DAC 104 of the source driver 50 of the present invention may reduce the linear error of the data voltage corresponding to the second part 2-5V and the third part 5-6V, and improve the linearity of the data voltage. In addition, it should be noted that in organic light-emitting diode (OLED) applications, the data voltage of 4-6V is sensitive to low grayscale application of the human eye.

On the other hand, in the source driver 50, the switch circuit 110 is coupled between the three sub-DACs and the SOP 106, and is configured to switch the first intermediate voltages VI1, the second intermediate voltages VI2 or the third intermediate voltage VI3 to be output to the SOP 106. The implementation of the switch circuit 110 is not limited, and those skilled in the art may make appropriate adjustments according to the system requirements. For example, the switch circuit 110 may be implemented by a plurality of switches and a logic circuit, as shown in FIG. 5. The logic circuit includes two exclusive-OR gates XOR and an AND gate AND. When the value of the data code is smaller than 512 (DA=0 and DAB=1), the switch circuit 110 switches the first sub-DAC to be coupled to the SOP 106, and switches the second sub-DAC and the third sub-DAC to be disconnected from the SOP 106; when the value of the data code is between 512 and 992 (DA=1 and DAB=0), the switch circuit 110 switches the second sub-DAC to be coupled to the SOP 106, and switches the first sub-DAC and the third sub-DAC to be disconnected from the SOP 106; when the value of the data code is greater than 992 (D[6]-D[9]=1, DB[6]-DB[9]=1 and DREAL=1), the switch circuit 110 switches the third sub-DAC to be coupled to the SOP 106, and switches the first sub-DAC and the second sub-DAC to be disconnected from the SOP 106. In this way, the SOP 106 of the source driver 50 may perform interpolation on the received first intermediate voltages VI1, the received second intermediate voltages VI2 or the received third intermediate voltage VI3 and amplify to generate the data voltage VOUT. It should be noted that the operation principle of the exclusive-OR gates XOR and the AND gate AND should be well known in the art, so it is not repeated here.

In summary, the source driver of the present invention may divide the gamma curve of the expected specifications of the display manufacturer for grayscale to data voltage into a plurality of parts and utilize a plurality of sub-DACs to respectively process the gamma voltages corresponding to the plurality of parts. In this way, compared with the prior art, the source driver of the present invention may optimize the linear errors corresponding to each part of the gamma curve, and improve the linearity of the data voltage

Those skilled in the art will readily observe that numerous modifications and alterations of the device and method may be made while retaining the teachings of the invention. Accordingly, the above disclosure should be construed as limited only by the metes and bounds of the appended claims.

1. A source driver, comprising:
a digital-to-analog converter (DAC), comprising:
a m-bit sub-DAC, configured to receive a plurality of first data codes within a plurality of data codes and generate a set of first intermediate voltages according to the plurality of first data codes; and
a k-bit sub-DAC, configured to receive a plurality of second data codes within the plurality of data codes and generate a set of second intermediate voltages according to the plurality of second data codes, wherein the first data codes and the second codes are different at least in partial bits; and
an operational amplifier, configured to output a data voltage according to the set of first intermediate voltages or the set of second intermediate voltages;
wherein m and k are positive integers.

2. The source driver of claim 1, further comprising:
a switch circuit, coupled between the DAC and the operational amplifier, configured to switch the m-bit sub-DAC or the k-bit sub-DAC to be coupled to the operational amplifier according to the plurality of first data codes and the plurality of second data codes.

3. The source driver of claim 2, further comprising:
an interpolation circuit, coupled between the switch circuit and the operational amplifier, configured to receive a plurality of third data codes within the plurality of data codes and perform an j-bit interpolation on the set of first intermediate voltages or the set of second intermediate voltages according to the plurality of third data codes, to generate at least one output voltage;
wherein the operational amplifier receives the at least one output voltage to generate the data voltage; and
wherein j is a positive integer.

4. The source driver of claim 3, further comprising:
a latch circuit, coupled to the DAC and the interpolation circuit, configured to store the plurality of data codes.

5. The source driver of claim 3, wherein m, k and j are the same or different.

6. The source driver of claim 1, wherein the plurality of data codes correspond to a full gamma voltage range.

7. The source driver of claim 6, wherein the plurality of first data codes correspond to a first part of the full gamma voltage range, and the plurality of second data codes correspond to a second part of the full gamma voltage range which do not overlap the first part.

8. The source driver of claim 1, further comprising:
a gamma voltage generation circuit, coupled to the m-bit sub-DAC and the k-bit sub-DAC and configured to generate a plurality of gamma voltages.

9. The source driver of claim 8, wherein the m-bit sub-DAC receives a plurality of first gamma voltages among the plurality of gamma voltages, and the k-bit sub-DAC receives a plurality of second gamma voltages among the plurality of gamma voltages, wherein the plurality of first gamma voltages are in a first part of a full gamma voltage range, and the plurality of second gamma voltages are in a second part of the full gamma voltage range which do not overlap the first part.

10. The source driver of claim 9, wherein a first voltage difference between any two of the plurality of first gamma voltages is different from a second voltage difference between any two of the plurality of second gamma voltages.
